(19) United States
(12) Patent Application Publication
(10) Pub. No.: US 2016/0044911 A1
(43) Pub. Date: Feb. 18, 2016

(54) Bracket and Hanger System to Aid in Hanging a Tree Stand

(71) Applicant: Ancestry Outdoors, LLC, Tallmadge, OH (US)

(72) Inventors: Daniel L. Bayus, Tallmadge, OH (US); James Steklachich, Sharon, PA (US)

(21) Appl. No.: 14/822,209

(22) Filed: Aug. 10, 2015

Related U.S. Application Data
(60) Provisional application No. 62/036,145, filed on Aug. 12, 2014.

(51) Int. Cl. A01M 31/02; F16M 13/02

(52) U.S. Cl. CPC A01M 31/02; F16M 13/02

(57) ABSTRACT

A mounting bracket and hanger system for securing a tree stand to a tree includes a mounting bracket comprising a body and at least one recess defined in the body, and a hanger comprising a securing member, a body, and at least one extension member extending from the body of the hanger. The at least one extension member of the hanger may be configured for insertion into the at least one recess of the mounting bracket. The securing member of the hanger may be configured for insertion into a solid object.

### CROSS REFERENCE TO RELATED APPLICATION

This application claims priority to U.S. Provisional Patent Application No. 62/036,145, filed Aug. 12, 2014, the disclosure of which is incorporated in its entirety by reference.

### BACKGROUND OF THE INVENTION

1. Field of the Invention

This disclosure relates generally to a mounting system and, more particularly, to a bracket and hanger system to aid in hanging a tree stand.

2. Description of Related Art

Tree stands are open or enclosed platforms typically used by hunters to assist in hunting various animals. The tree stand platforms are secured to trees to elevate the hunter and give him/her a better vantage point when looking for animals. Tree stands enable the hunter to view a wide range of space, while remaining hidden from the hunted animals. The tree stands are erected by the hunters and may be kept in the tree during the entirety of the hunting season.

Currently, several different types of tree stands are commonly used by hunters. One type of tree stand is a hanging tree stand. Hanging tree stands typically include two parts, a standing platform and a seat. Legs may be used to connect the two parts to ensure a secure connection between the standing platform and the seat. There are several different ways to secure the hanging tree stands to a tree. One commonly used method for securing the hanging tree stand to the tree includes climbing a tree using a ladder, insertable steps, or the limbs of the tree to a desired height for the hanging tree stand. Once the hunter reaches the desired hanging height, the hanging tree stand is secured to the tree using straps, chains, bolts, or cables. After the hanging tree stand is secured, the tree stand is held on the tree by the lassoed straps, chains, bolts, or cables. The hunter can then sit on the seat of the tree stand and hunt comfortably from this position.

Although hanging tree stands are popular among hunters, the hanging tree stands are also very dangerous. A significant number of deaths and injuries are experienced every hunting season by hunters that have not properly secured their hanging tree stands to the tree. It is often the case that the straps securing the standing platform or seat to the tree break or disconnect from the hanging tree stand, and the standing platform and/or seat fall out of the tree. The hunter, in turn, is dropped out of the tree stand and can experience significant injuries or even a fatality depending on the height of the tree stand.

In view of the foregoing, a need exists for a mounting or securing system that provides a secure connection between a tree stand and a tree. A further need exists for a mounting or securing system that is readily installed with little effort from a hunter. An even further need exists for an improved method of securing a tree stand to a tree that overcomes the shortcomings of the existing installation methods.

### SUMMARY OF THE INVENTION

Accordingly, and generally, a bracket and hanger system and a method of securing a tree stand to a tree are provided to address and/or overcome some or all of the deficiencies or drawbacks associated with existing tree stand installation structures.

In accordance with one embodiment, a mounting bracket and hanger system for securing a tree stand to a tree may include a mounting bracket including a body and at least one recess defined in the body, and a hanger including a securing member, a body, and at least one extension member extending from the body of the hanger. The at least one extension member of the hanger may be configured for insertion into the at least one recess of the mounting bracket. The securing member of the hanger may be configured for insertion into a solid object.

The at least one recess may include two recesses. The at least one extension member may include two extension members. The hanger may include at least two plates provided on an end of the at least one extension member opposite the body. The mounting bracket may abut the at least two plates when mounted on the hanger. The securing member may include threading. The securing member may have a conical shape. The body may extend substantially perpendicularly relative to the at least one extension member. The mounting bracket may define a plurality of holes to assist in attaching the mounting bracket to a tree stand.

In accordance with another embodiment, a tree stand assembly may include a tree stand, a mounting bracket secured to the tree stand, and a hanger including a securing member, a body, and at least one extension member extending from the body of the hanger. The mounting bracket may include a body and at least one recess defined in the body. The at least one extension member of the hanger may be configured for insertion into the at least one recess of the mounting bracket. The securing member of the hanger may be configured for insertion into a solid object.

In accordance with a further embodiment, a method of securing a tree stand to a solid object may include the steps of securing a mounting bracket to a tree stand; securing a hanger to a solid object; and securing the mounting bracket to the hanger. The method may also include threadedly securing the hanger in the solid object by rotating the hanger relative to the solid object. The method may also include resting the mounting bracket on an upper surface of the hanger to secure the mounting bracket on the hanger. The method may also include inserting fasteners through the mounting bracket into the tree stand to secure the mounting bracket to the tree stand.

These and other features and characteristics of the bracket and hanger system, as well as the methods of installation and function of the related elements of structures and combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a front view of a mounting bracket in accordance with one embodiment of the present disclosure;

FIG. 2 is a front perspective view of the mounting bracket of FIG. 1;

FIG. 3 is a side perspective view of a hanger in accordance with one embodiment of the present disclosure;

FIG. 4 is a top view of the hanger of FIG. 3;

FIG. 5 is a side view of the hanger of FIG. 3;

FIG. 6 is a front view of the hanger of FIG. 3;

FIG. 7 is a rear view of the hanger of FIG. 3;

FIG. 8 is a front view of a mounting bracket in accordance with another embodiment of the present disclosure;

FIG. 9 is a front perspective view of the mounting bracket of FIG. 8;

FIG. 10 is a side perspective view of a hanger in accordance with another embodiment of the present disclosure;

FIG. 11 is a top view of the hanger of FIG. 10;

FIG. 12 is a side view of the hanger of FIG. 10;

FIG. 13 is a front view of the hanger of FIG. 10;

FIG. 14 is a rear view of the hanger of FIG. 10;

FIG. 15 is a front perspective view of the mounting bracket of FIG. 1 secured to the legs of a tree stand;

FIG. 16 is a side view of a mounting bracket and hanger system secured to a tree;

FIG. 17 is a side view of a tree stand assembly secured to a tree; and

FIG. 18 is a front view of a mounting bracket secured to a hanger.

### DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawings. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

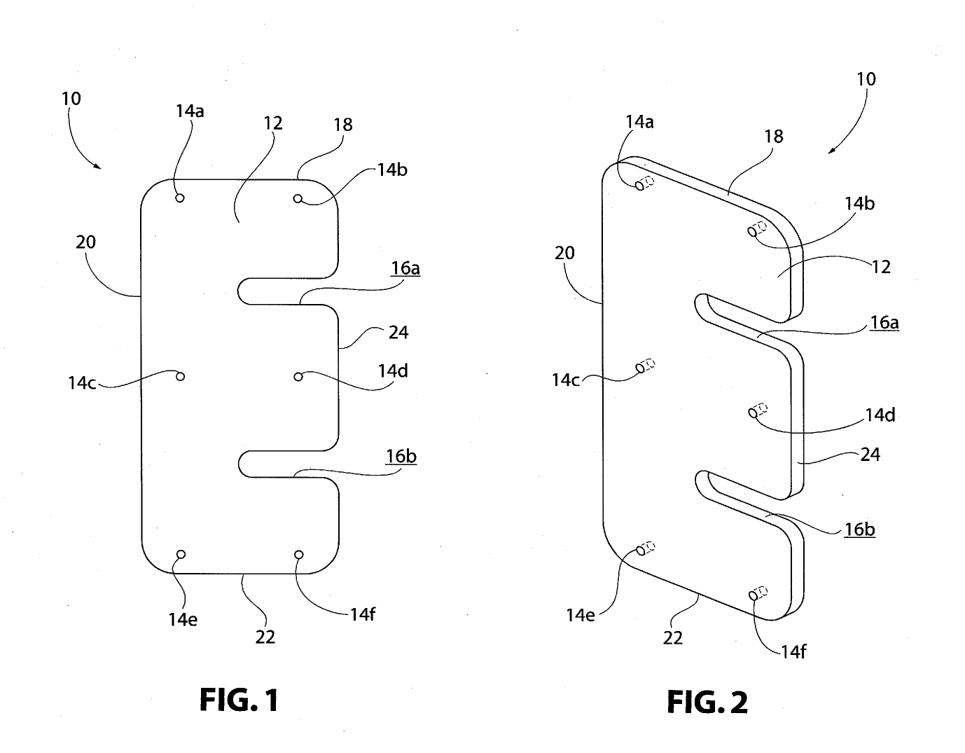

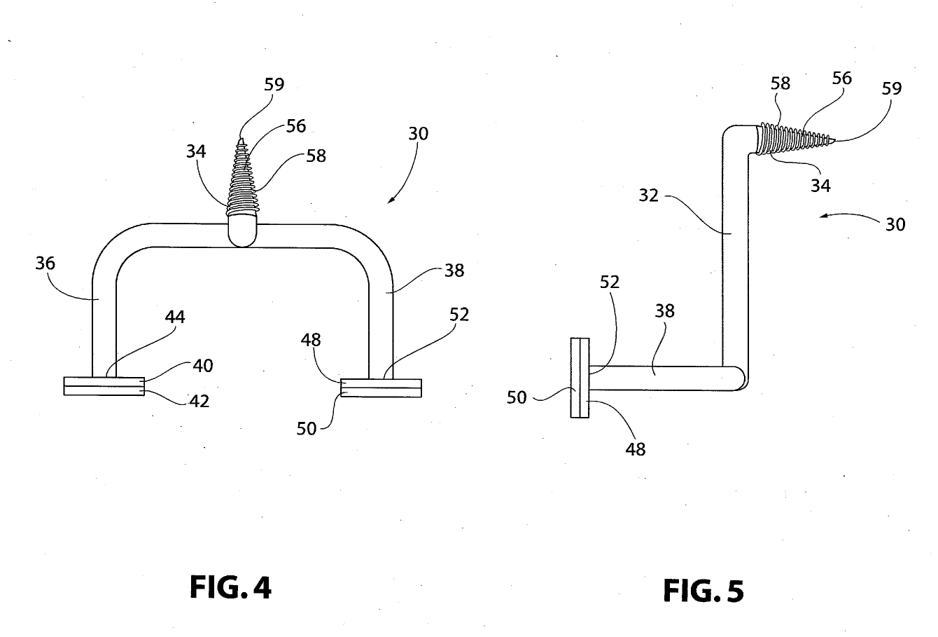

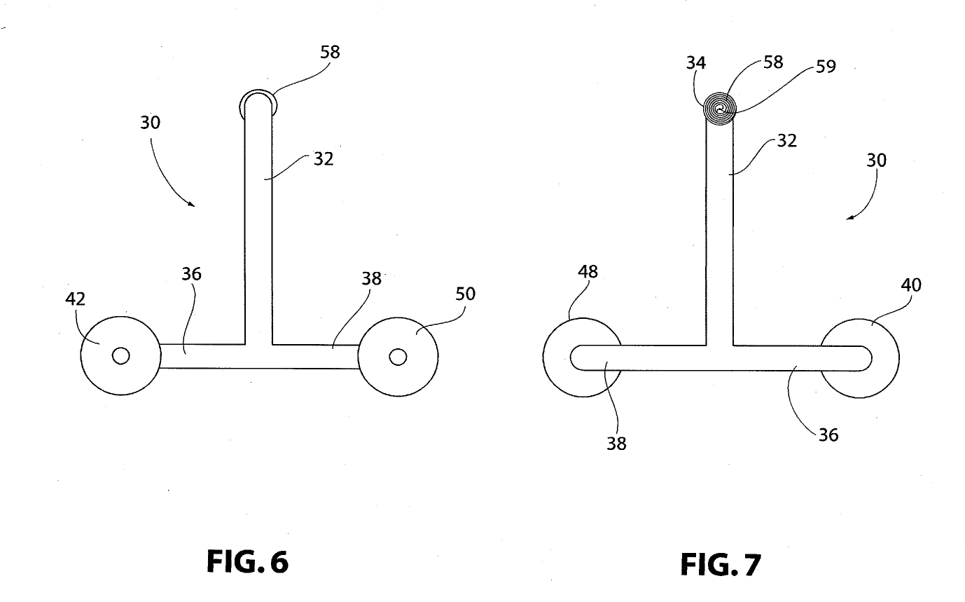

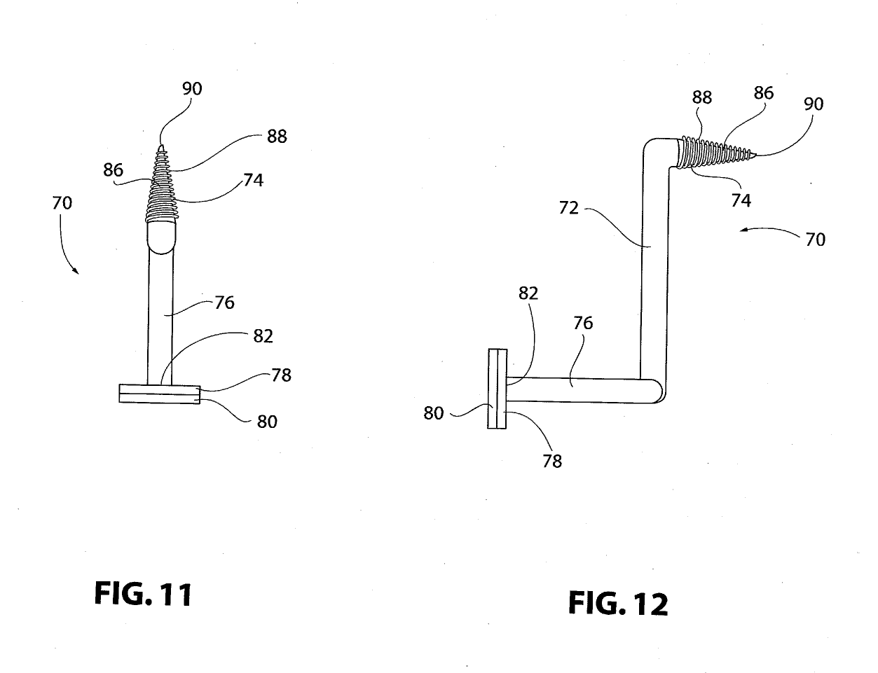

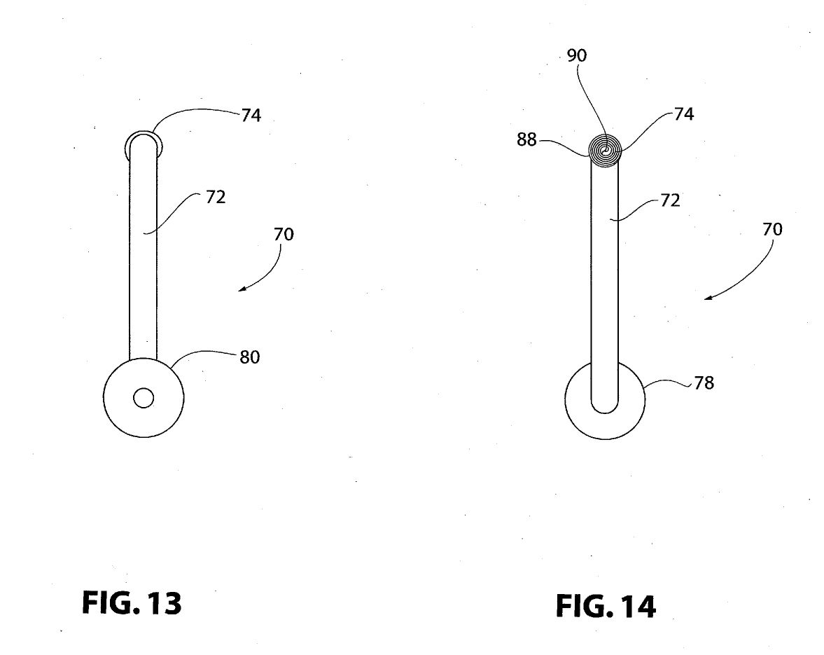

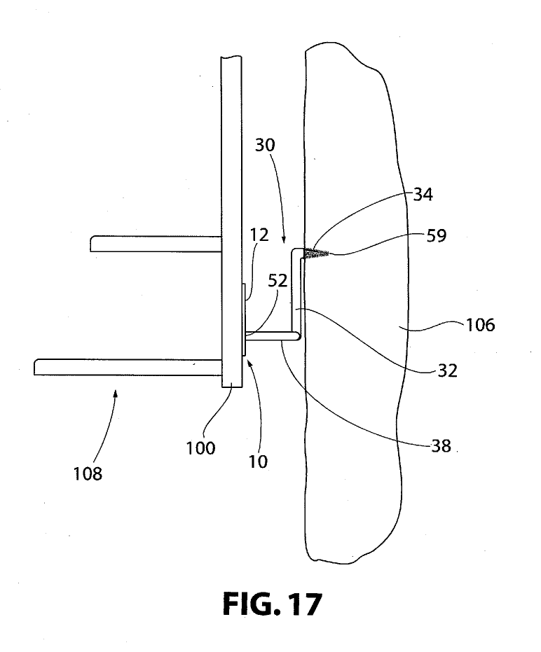

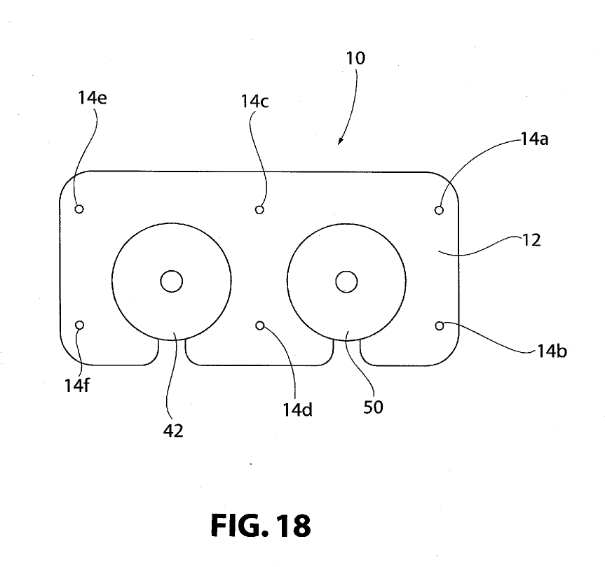

The present disclosure is directed to, in general, a system for securing a tree stand to a tree and, in particular, a bracket and hanger system for securing the tree stand to the tree. Certain preferred and non-limiting embodiments of the system are illustrated in FIGS. 1-18. The bracket and hanger system will now be described in detail, followed by a description of the use and installation of the system on the tree.

With reference to FIGS. 1 and 2, a mounting bracket 10 is shown. The mounting bracket 10 includes a body 12, a plurality of holes 14a-14f extending through the body 12, and at least two recesses 16a, 16b defined in the body 12. The body 12 has a generally rectangular shape, but it is to be understood that additional shapes may be used, such as square, oval, or triangular. In one embodiment, the mounting bracket 10 is made of steel and, more particularly, 10 gauge standard steel. It is to be understood, however, that alternative materials may be used, such as different metals, plastic, wood, or any other stiff, rigid material. The body 12 may include rounded corners, but it is also contemplated that additional types of corners may be used, such as chamfered or straight edge corners.

The plurality of holes 14a-14f are circular in cross section and extend from one side of the body 12 through to an opposing side of the body 12. The holes 14a-14f are configured to receive a fastener, such as a screw, bolt, or nail, among other types of fasteners. At least two of the holes 14a, 14b may be positioned near a first side 18 of the body 12. At least one of the holes 14c may be positioned near a second side 20 of the body 12. At least two of the holes 14e, 14f may be positioned near a third side 22 of the body 12. At least one of the holes 14d may be positioned near a fourth side 24 of the body 12. Holes 14a, 14c, and 14e may be spaced equally apart from one another. Likewise, holes 14a and 14b, 14c and 14d, and 14e and 14f may be spaced equally apart from one another, respectively. Holes 14a, 14c, and 14e may be positioned in line with one another along a longitudinal axis of the body 12. Similarly, holes 14b, 14d, and 14f may be positioned in line with one another along a longitudinal axis of the body 12. The holes 14a, 14c, and 14e may be arranged parallel to the opposing holes 14b, 14d, and 14f.

The recesses 16a, 16b may extend from the fourth side 24 of the body 12 towards the center of the body 12. In one embodiment, the recesses 16a, 16b extend to the center of the body 12. The recesses 16a, 16b may extend parallel to one another and perpendicular to a longitudinal axis of the body 12. The recesses 16a, 16b are configured to receive portions of the hanger, which will be described hereinbelow. Although only two recesses are shown, it is to be understood that any number of recesses may be defined in the body 12, including one, three, four, or more.

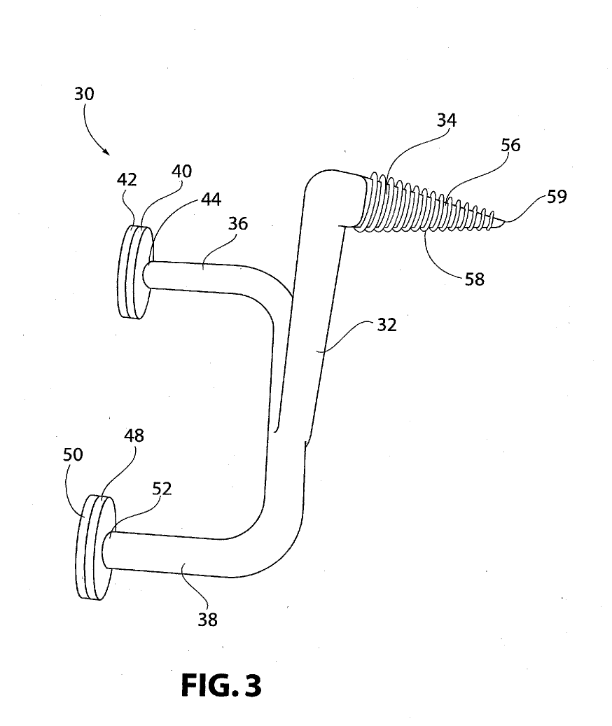

With reference to FIGS. 3-7, a hanger 30 to be used in conjunction with the mounting bracket 10 is shown. The hanger 30 includes a body 32, a securing member 34, a first extension member 36, and a second extension member 38. The body 32, the first extension member 36, and the second extension member 38 may be substantially cylindrical. It is to be appreciated, however, that these elements could have a square, triangular, or trapezoidal-shaped cross section. The hanger 10 may be manufactured from metal, but it is also to be understood that alternative materials may be used. The body 32 may extend upwardly from and perpendicular to the first and second extension members 36, 38.

The first and second extension members 36, 38 may extend parallel to one another and away from the body 32. A first plate 40 and a second plate 42 may be secured to one end 44 of the first extension member 36. The first plate 40 and the second plate 42 may abut one another on the end 44 of the first extension member 36. The first and second plates 40, 42 may be circular, but additional shapes are also contemplated, such as triangular or trapezoidal. It is also contemplated that the first and second plates 40, 42 may be movable along the first extension member 36 to adjust the position of the first plate 40 and the second plate 42.

Similarly, a third plate 48 and a fourth plate 50 may be secured to one end 52 of the second extension member 38. The third plate 48 and the fourth plate 50 may abut one another on the end 52 of the extension member 38. The third and fourth plates 48, 50 may be circular, but additional shapes are also contemplated, such as triangular or trapezoidal. It is also contemplated that the third and fourth plates 48, 50 may be movable along the length of the second extension member 38 to adjust the position of the third plate 48 and the fourth plate 50.

The securing member 34 of the hanger 30 includes a conical portion 56 and threading 58 provided on an outer surface of the conical portion 56. The threading 58 may be spiraled in a helical fashion along the conical portion 56 of the securing member 34. Other threading arrangements are also contemplated. A tip 59 may also be provided on an end of the conical portion 56. The tip 59 may assist in piercing an object or surface, such as a tree, when securing the hanger 30 to the object.

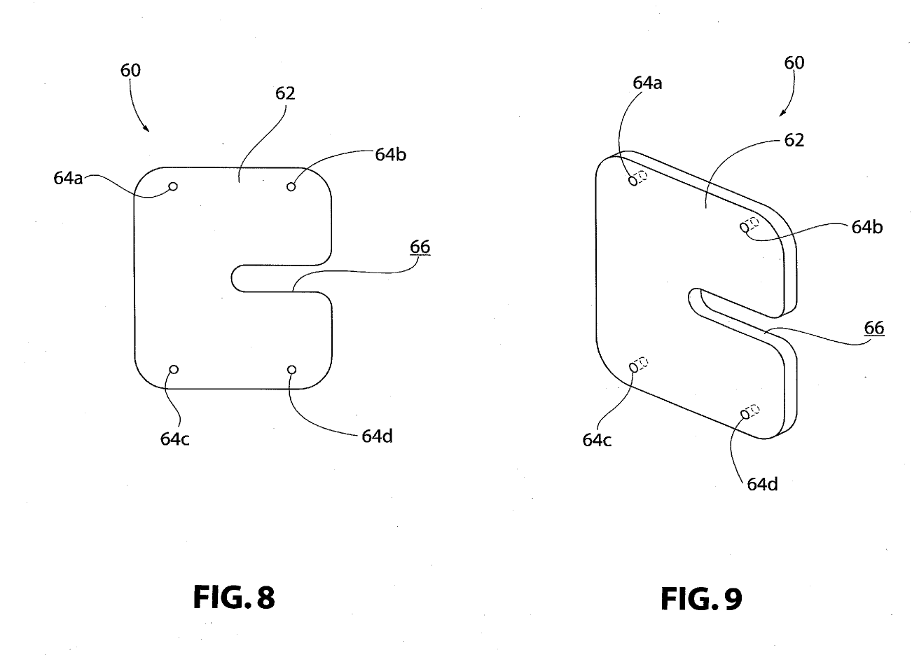

With reference to FIGS. 8 and 9, another embodiment of a mounting bracket 60 is shown. This embodiment of the mounting bracket 60 is similar to the previous embodiment of the mounting bracket 10 but with a few differences. The mounting bracket 60 includes a body 62, a plurality of holes 64a-64d, and a recess 66 defined in the body 62. The body 62 has a generally square shape, but it is to be understood that additional shapes may be used, such as rectangular, oval, or triangular. In one embodiment, the mounting bracket 60 is made of steel and, more particularly, 10 gauge standard steel. It is to be understood, however, that alternative materials may be used, such as different metals, plastic, wood, or any other stiff, rigid material. The body 62 may include rounded corners, but it is also contemplated that additional types of corners may be used, such as chamfered or straight edge corners.

The plurality of holes 64a-64d are circular in cross section and extend from one side of the body 62 through to an opposing side of the body 62. The holes 64a-64d are configured to receive a fastener, such as a screw, bolt, or nail, among other types of fasteners. In one embodiment, at least one hole 64a-64d may be positioned in each corner of the body 62. The holes 64a-64d may be spaced an equal distance apart from one another.

The recess 66 may extend from one side of the body 62 towards an inner portion of the body 62. In one embodiment, the recess 66 may extend to the center of the body 62. The recess 66 is configured to receive portions of the hanger, which will be described in further detail hereinbelow.

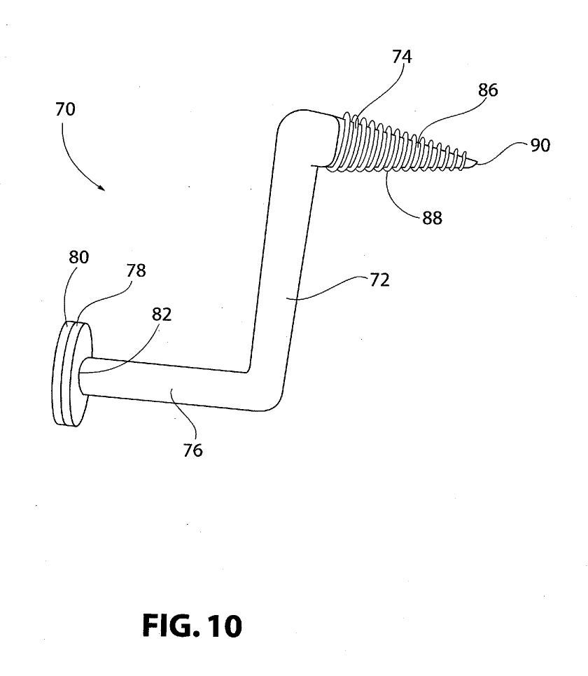

With reference to FIGS. 10-14, another embodiment of a hanger 70 is shown. This embodiment of the hanger 70 is similar to the previous embodiment of the hanger 30 but with a few differences. The hanger 70 includes a body 72, a securing member 74, and an extension member 76. The body 72 and the extension member 76 may be substantially cylindrical. It is to be appreciated, however, that these elements could have a square, triangular, or trapezoidal shaped cross section. The hanger 70 may be manufactured from metal, but it is also to be understood that alternative materials may be used. The body 72 may extend upwardly from and perpendicularly to the extension member 76.

The extension member 76 may extend away from the body 72. A first plate 78 and a second plate 80 may be secured to one end 82 of the extension member 76. The first plate 78 and the second plate 80 may abut one another on the extension member 76. The first and second plates 78, 80 may be circular, but additional shapes are also contemplated, such as triangular or trapezoidal. It is also contemplated that the first and second plates 78, 80 may be movable along the length of the extension member 76 to adjust the location of the first plate 78 and second plate 80.

The securing member 74 of the hanger 70 includes a conical portion 86 and threading 88 provided on an outer surface of the conical portion 86. The threading 88 may be spiraled in a helical fashion along the conical portion 86 of the securing member 74. Other threading arrangements are also contemplated. A tip 90 may also be provided on an end of the conical portion 86. The tip 90 may assist in piercing an object or surface, such as a tree, when securing the hanger 70 to the object.

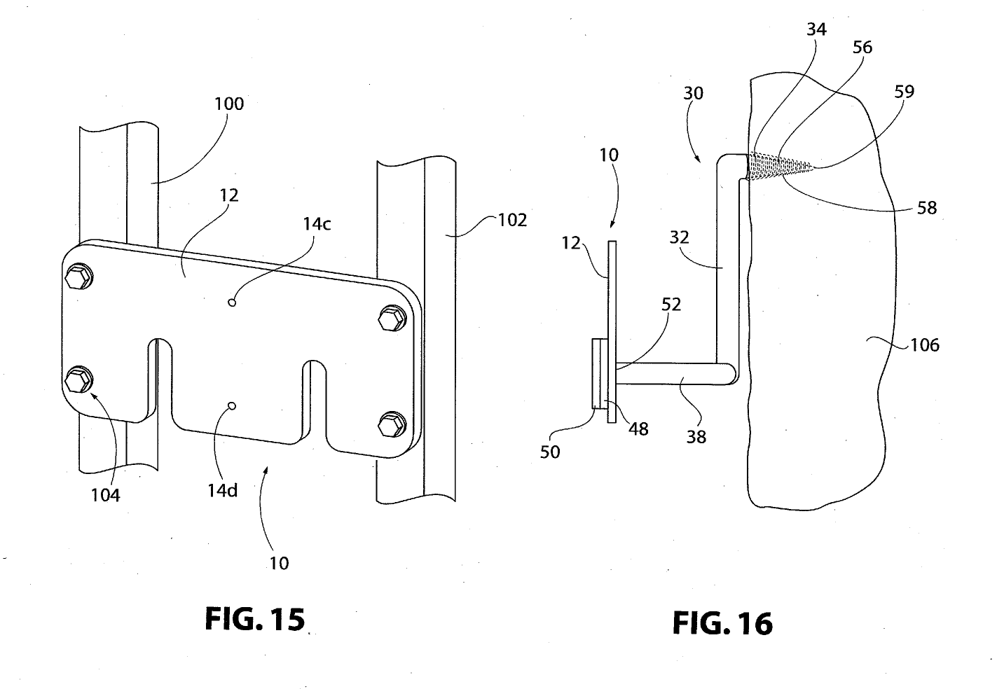

With reference to FIGS. 15-17, a method of attaching a mounting bracket and hanger system to a tree stand to aid in hanging a tree stand is described. A first step of the method includes securing the mounting bracket 10 to legs 100, 102 or structure of a tree stand. It is to be understood that the mounting bracket 10 does not have to be secured to the legs 100, 102 of the tree stand, but may be secured to another suitable part of the tree stand structure. Fasteners 104 are inserted through the holes 14a-14f of the mounting bracket 10, thereby securing the mounting bracket 10 to the tree stand legs 100, 102. The mounting bracket 10 may be secured to two legs 100, 102 of the tree stand (as shown in FIG. 15) or three legs. It is also contemplated that the second embodiment of the mounting bracket 60 may be secured to just one leg of the tree stand (not shown). In one embodiment, the mounting bracket 10 is secured to the legs 100, 102 of the tree stand using a hex bolt and locking nut. It is also to be appreciated that alternative fasteners may be used instead of the hex bolt and locking nut, such as a screw, nail, or clamp.

As shown in FIG. 16, after the mounting bracket 10 has been secured to the tree stand, the hanger 30 may be secured to a solid object or surface, such as a tree 106. The tip 59 of the securing member 34 of the hanger 30 is rotated to pierce the surface of the tree 106. As the hanger 30 is rotated, the securing member 34 is inserted further into the tree 106. The threading 58 of the conical portion 56 is used to create a secure connection between the tree 106 and the securing member 34. The hanger 30 may be rotated until the entire or only a portion of the conical portion 56 is inserted into the tree 106.

As shown in FIGS. 3, 17, and 18, after the hanger 30 has been secured to the tree 106, the mounting bracket 10 is inserted onto the extension members 36, 38 of the hanger 30. The recesses 16a, 16b of the mounting bracket 10 are positioned above the extension members 36, 38 and removably positioned thereon. The mounting bracket 10 is lowered onto the extension members 36, 38 until the body 12 of the mounting bracket 10 comes to rest on the extension members 36, 38. In one embodiment, the mounting bracket 10 is secured to the hanger 30 using a friction fit. It is also to be contemplated that the mounting bracket 10 may be secured to the hanger 30 using a snap fit or fasteners. In this manner, the tree stand 108 is secured to the hanger 30, which aids in securing the tree stand 108 to the tree 106. By using this system, the tree stand 108 is more efficiently and securely positioned on the tree 106. In the event of one of the tree stands 108 straps becoming dislodged or broken, the hanger 30 and mounting bracket 10 will keep the tree stand 108 secured to the tree 106.

While several embodiments of a mounting bracket and hanger system are shown in the accompanying figures and described hereinabove in detail, other embodiments will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A mounting bracket and hanger system for securing a tree stand to a tree, comprising:
a mounting bracket comprising a body and at least one recess defined in the body; and
a hanger comprising a securing member, a body, and at least one extension member extending from the body of the hanger,
wherein the at least one extension member of the hanger is configured for insertion into the at least one recess of the mounting bracket, and
wherein the securing member of the hanger is configured for insertion into a solid object.

2. The mounting bracket and hanger system as claimed in claim 1, wherein the at least one recess comprises two recesses.

3. The mounting bracket and hanger system as claimed in claim 1, wherein the at least one extension member comprises two extension members.

4. The mounting bracket and hanger system as claimed in claim 1,
wherein the hanger further comprises at least two plates provided on an end of the at least one extension member opposite the body, and
wherein the mounting bracket abuts the at least two plates when mounted on the hanger.

5. The mounting bracket and hanger system as claimed in claim 1, wherein the securing member includes threading.

6. The mounting bracket and hanger system as claimed in claim 1, wherein the securing member has a conical shape.

7. The mounting bracket and hanger system as claimed in claim 1, wherein the body extends substantially perpendicularly relative to the at least one extension member.

8. The mounting bracket and hanger system as claimed in claim 1, wherein the mounting bracket defines a plurality of holes to assist in attaching the mounting bracket to a tree stand.

9. A tree stand assembly, comprising:
a tree stand;
a mounting bracket secured to the tree stand, the mounting bracket comprising a body and at least one recess defined in the body; and
a hanger comprising a securing member, a body, and at least one extension member extending from the body of the hanger,
wherein the at least one extension member of the hanger is configured for insertion into the at least one recess of the mounting bracket, and
wherein the securing member of the hanger is configured for insertion into a solid object.

10. The tree stand assembly as claimed in claim 9, wherein the at least one recess comprises two recesses.

11. The tree stand assembly as claimed in claim 9, wherein the at least one extension member comprises two extension members.

12. The tree stand assembly as claimed in claim 9,
wherein the hanger further comprises at least two plates provided on an end of the at least one extension member opposite the body, and
wherein the mounting bracket abuts the at least two plates when mounted on the hanger.

13. The tree stand assembly as claimed in claim 9, wherein the securing member includes threading.

14. The tree stand assembly as claimed in claim 9, wherein the securing member has a conical shape.

15. The tree stand assembly as claimed in claim 9, wherein the body extends substantially perpendicularly relative to the at least one extension member.

16. The tree stand assembly as claimed in claim 9, wherein the mounting bracket defines a plurality of holes to assist in attaching the mounting bracket to the tree stand.

17. A method of securing a tree stand to a solid object, comprising:
a) securing a mounting bracket to a tree stand;
b) securing a hanger to a solid object; and
c) securing the mounting bracket to the hanger.

18. The method of securing a tree stand to a solid object as claimed in claim 17, further comprising threadedly securing the hanger in the solid object by rotating the hanger relative to the solid object.

19. The method of securing a tree stand to a solid object as claimed in claim 17, further comprising resting the mounting bracket on an upper surface of the hanger to secure the mounting bracket on the hanger.

20. The method of securing a tree stand to a solid object as claimed in claim 17, further comprising inserting fasteners through the mounting bracket into the tree stand to secure the mounting bracket to the tree stand.
